(19) United States
(12) Patent Application Publication
(10) Pub. No.: US 2007/0216077 A1
(43) Pub. Date: Sep. 20, 2007

(54) Hand-guided dolly for transporting heavy power tools

(76) Inventors: Matthias Keith, Kaufbeuren (DE); Thomas Baur, Lamerdingen (DE); Roland Imhof, Langerringen/Schwabmuehlhausen (DE); Alexander Buchenau, Purgen (DE)

Correspondence Address: ABELMAN, FRAYNE & SCHWAB, 666 THIRD AVENUE, 10TH FLOOR, NEW YORK, NY, 10017, US

(21) Appl. No.: 11/713,582

(22) Filed: Mar. 1, 2007

(30) Foreign Application Priority Data
Mar. 3, 2006 (DE) 10 2006 000 105.2

(51) Int. Cl. B23Q 3/00

(52) U.S. Cl. 269/17; 280/47.28; 414/467

(57) ABSTRACT

A hand-guided dolly for transporting heavy power tools includes two handlebars (12) defining a frame plane and having first and second end regions and at least one handle (13) located in the first end region (14), a load shovel (16) provided at the second end region (15) of the handlebars (12) and projecting away from the frame plane (E) substantially perpendicular thereto, two running wheels (21) the axis of which extends parallel to the frame plane E, and a holding device (31) for holding a heavy power tool (6) on the dolly and including a stop yoke (32) pivotal between a first position in which the power tool (6) can be placed on the dolly (11), and a second position in which the power tool (6) is secured on the dolly (11) with the stop yoke (32) for being transported on the dolly (11).

### BACKGROUND OF THE INVENTION

1. Field of the Invention

The present invention relates to a hand-guided dolly for transporting heavy power tools and including two handlebars defining a frame plane and having at least one handle in their first end region, a load shovel provided at a second end region of the handlebars and projecting away from the frame plane substantially perpendicular thereto, at least one running wheel a wheel axle of which extends parallel to the frame plane, and a holding device for a heavy power tool.

2. Description of the Prior Art

Heavy power tools such as, e.g., chisel hammers often have a weight of 25 kg or more, and after being unloaded from a transportation vehicle, they are transported with a dolly to a respective location on a constructional site.

British Patent No. 1,214,888 discloses a hand-guided dolly for heavy power tools and which includes two handlebars, a load shovel in the form of a pan, two running wheels, and a holding device for retaining the tool during transportation.

The handlebars define a frame plane. In the first end region of the handlebars, each handlebar is provided with a handle. The load shovel is provided at the second end region of the handlebars and projects from the frame plane of the handlebar substantially perpendicular to the frame plane. The, placed on a dolly, power tool is secured against slippage in the region of its working tool holder with the load shovel of the dolly. The running wheels are supported on a wheel axle extending parallel to the frame plane. The holding device for the power tool includes two holding plates projecting from the frame plane perpendicular thereto. The holding plates have receptacles for holding the power tool during its transportation on a dolly. In order to additionally secure the loaded power tool, a U-shaped stirrup can be provided which braces crossbars located in the frame plane.

The drawback of the known dolly resides in that the heavy power tool has to be brought out of the load shovel and should be additionally aligned relative to the holding plates. For a single user this is very strenuous. On uneven path stretches which are often common on constructional sites, the loaded power tool should be additionally secured. The U-shaped stirrup which is disclosed in British Patent No. 1,214,888 meets this requirement. However, securing of the U-shaped stirrup with nuts is very expensive, and in particular, when a power tool should be transported with the dolly over a short stretch to a next operational location.

Accordingly, an object of the present invention is a hand-guided dolly for transporting heavy power tools which would enable a simple and reliable fixing of a heavy power tool on the dolly.

### SUMMARY OF THE INVENTION

This an other objects of the present invention, which will become apparent hereinafter, are achieved by providing a dolly of the type discussed above and the holding device of which includes a stop yoke pivotal about a pivot axis, which extends parallel to the frame plane, between a first position in which the power tool can be placed on the dolly, and a second position in which the power tool is secured on the dolly with the stop yoke for being transported on the dolly.

The stop yoke surrounds the power tool, at least regionwise, in its second position and secures it against slipping from the dolly even when transporting

However, advantageously, the load shovel has a pan-shaped receptacle that has a front border which is adjacent to the power tool, when the power tool is loaded, and which is deeper or lower than the rear, e.g., lower than the side boarders of the pan-shaped receptacle. After the power tool has been delivered to an operational site, the stop yoke is pivoted into its first position, and the heavy power tool can be easily unloaded from the dolly by inclining the dolly. For loading the dolly, the stop yoke is pivoted into its first position, and the heavy power tool is loaded on the load shovel by being slightly lifted, and is secured with the stop yoke upon the stop yoke being pivoted into its second position. The loaded power tool is automatically aligned and is reliably secured for subsequent transportation. An expensive fixation of the power tool and/or the need to lift it over a noticeable height is eliminated with the inventive dolly.

Advantageously, the pivot axis of the stop yoke extends parallel to the frame plane, so that upon pivoting the stop yoke in the second position, the power tool is surrounded by the yoke from above at least regionwise. Thereby, an easy handling of the holding device is ensured.

Preferably, the pivot axis of the stop yoke is located in front of the frame plane one a side of the plane on which the load shovel is located. Thereby, an easy pivotability of the stop yoke is ensured.

Advantageously, the stop yoke is provided with a handle section for gripping and pivoting the stop yoke. The handle section ensures an easy gripping of the stop yoke and its pivotal movement in a desired position. For a better gripping of the stop yoke, the handle section can have an appropriate profile or at least have a grip sleeve arranged on the stop yoke.

Advantageously, the handle section is formed by a bent section of the stop yoke, which ensures an economical manufacturing of the stop yoke and, thereby, of the entire dolly.

Advantageously, a spring member is provided for biasing the stop yoke to one of its first and second positions, preferably to the second position. The spring member is formed as a torsion spring, preferably, a leg spring formed as a helical spring, the ends of which are essentially straight, with one end adjoining the stop yoke and the other end adjoining the handlebar. The spring member additionally secures the stop yoke in its second position. Alternatively, the spring member can be so arranged that it contributes to the pivotal displacement of the stop yoke to the first position. With the alternative embodiment of the spring member, in order to prevent an inadvertent opening of the holding device during the transportation of the device, the stop yoke should be pivoted to a certain extent from the second position before the spring member starts to contribute to the displacement of the stop yoke to its first position.

To facilitate handling of the stop yoke, there is provided at least one stop for limiting the maximal movement of the stop yoke.

Advantageously, the stop is formed by a bent section of the stop yoke that extends from the pivot axis through the frame plane defined by the handlebars. The stop yoke can be formed, e.g., from a tubular profiled part the desired shape of which is obtained using a bending process.

Advantageously, the stop yoke has a connection section located with respect to the load shovel behind the frame plane.

Advantageously, the free ends of the stop yoke are connected with each other. Thereby, a stable stop yoke is produced.

Advantageously, on the connection section, there is provided a coupling section for engagement by a lifting device. The coupling section can be formed e.g., as a crane hook. When the lifting device imparts a pulling force acting upwardly, the stop yoke pivots over its second position, pressing the power tool on the dolly. This design of the stop yoke is particularly advantageous when a lifting device such as a crane or the like is used for displacing a heavy power tool arranged on the dolly. It is further advantageous when in addition to the coupling section, the stop yoke has a pivot axis that is arranged in front of the frame plane on the side of the load shovel. Thereby the power tool is reliably held when lifted by a lifting device upwardly.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of a dolly according to the present invention with the stop yoke in a second position;

FIG. 2 a partial side view of the stop yoke in a first position; and

FIG. 3 a perspective view of the stop yoke in the second position.

In the drawing the same parts are designated with the same reference numerals.

### DETAILED DESCRIPTION OF THE PREFERRED EMBODIMENTS

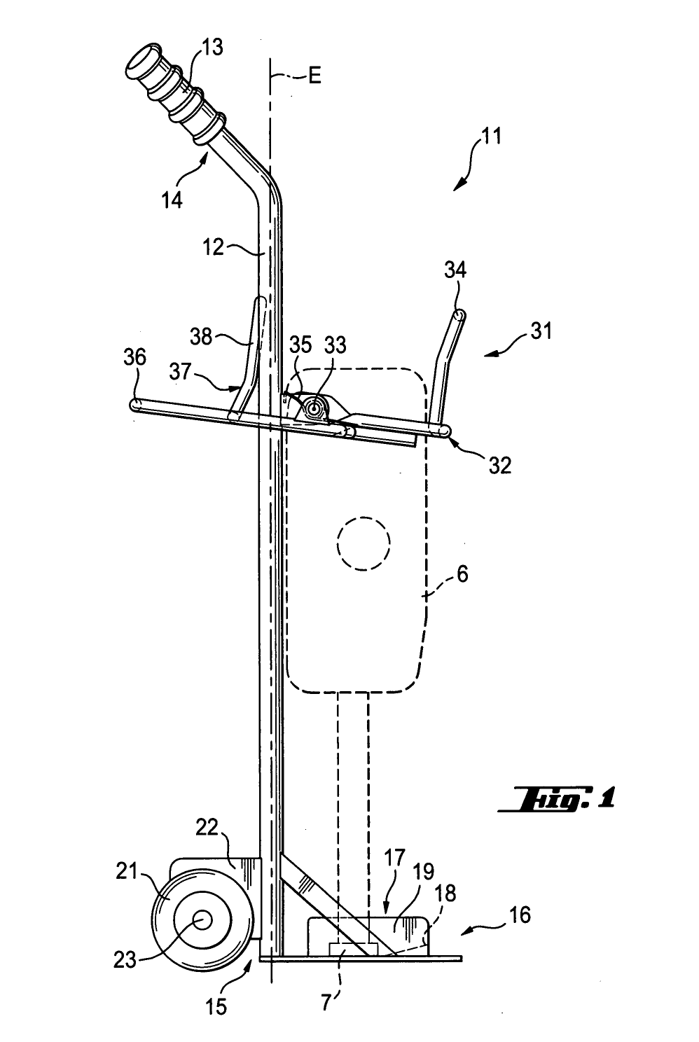

A hand-guided dolly 11, which is shown in FIGS. 1-3, is designed for carrying heavy power tools such as, e.g., a chisel hammer and includes two handlebars 12, a load shovel 16, two running wheel 21, and a holding device 31 for a power tool 6.

The handlebars 12 define a frame plane E and have each a handle 13 in their first end region 14. The load shovel 16 is arranged at a second region 15 of the handlebars 12 and extends transverse to the frame plane E.

The load shovel 16 has a pan-shaped receptacle 17, e.g., for a working tool holder 7 of the power tool 6. The front border 18 of the receptacle 17 is formed lower than other borders 19 of the receptacle 17.

At the second end 15 of the handlebars 12, the two running wheels 21 are secured to the handlebars 12 with an axle mount 22. The wheel axles 23 extend parallel to each other and are spaced from the frame plane E and are located behind the frame plane E with respect to the load shovel 16.

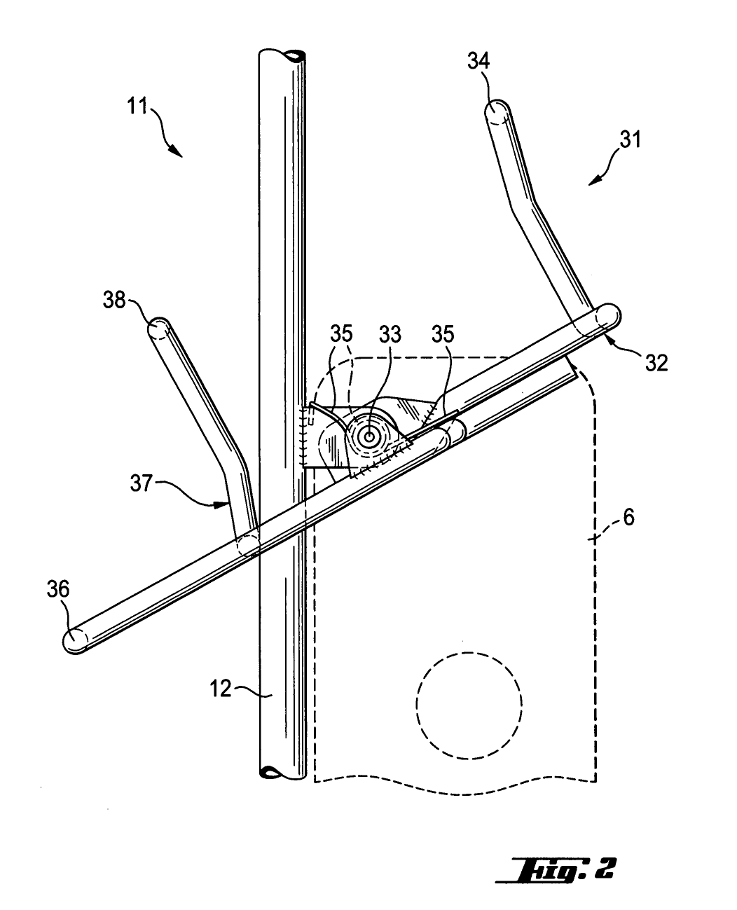

The holding device 31 includes a stop yoke 32 that pivots about a pivot axis 33 from a first position (according to FIG. 2) in which the power tool 6 can be placed on the dolly 11, to a second position (according to FIG. 1) in which the stop yoke 32 holds the power tool on the dolly 11. The pivot axis 33 extends parallel to the frame plane E and is located in front of the frame plane E on the side of the load shovel 16.

The stop yoke 32 is provided with a handle section 34 for holding and pivoting the stop yoke 32 and which is formed by a bent section of the stop yoke 32. The stop yoke is biased by a spring member 35 formed as a torsion spring, with one leg of the torsion spring acting on the stop yoke 32 and another leg of the torsion spring acting on the handlebar 12.

In order to limit the maximal pivotal movement of the stop yoke, there are provided two stops 36 that are formed by bent sections of the stop yoke 32 and extend from the pivot axis 33 through the frame plane E defined by the handlebars 12. The stop yoke 32 further has a connection section 37 that is located behind the frame plane E relative to the load shovel 16. A crane hook section in the form of a coupling section 38 is provided on the connection section 37 for engagement by a crane that serves as a lifting device.

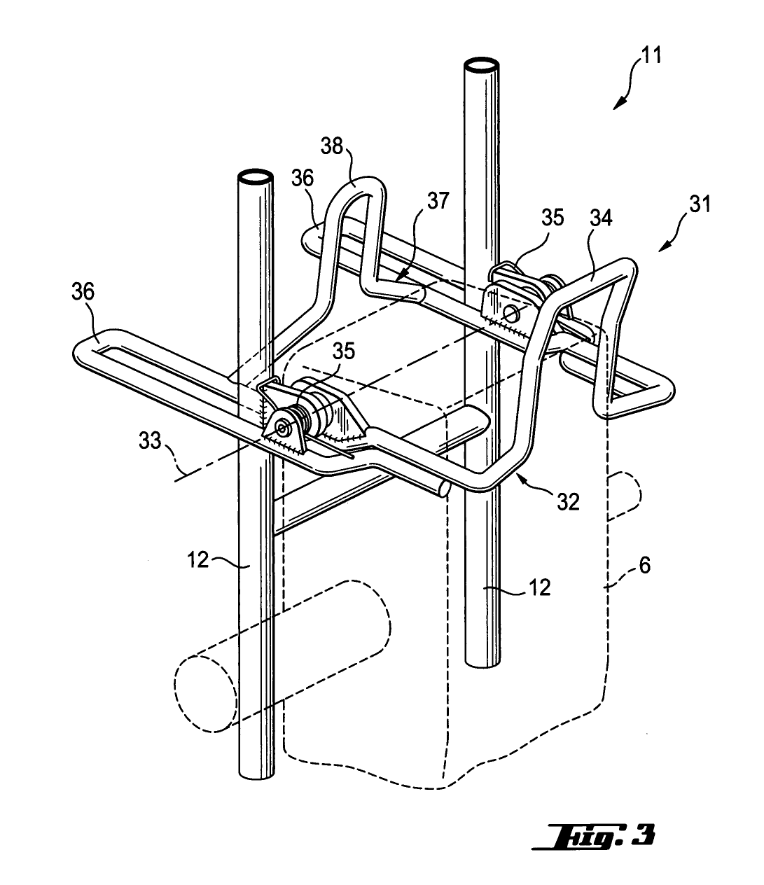

For loading the dolly 11, the stop yoke 32 is pivoted with a handle 34 in a first position (FIG. 2). The power tool 6, together with the working tool holder 7 is placed on the load shovel 16 and is rested against the handlebars 12. Then, the stop yoke 32 is pivoted in the second position (FIGS. 1 and 3), with the stop yoke 32 surrounding the power tool 6 at least regionwise for securing the power tool 6 on the dolly 11 for transporting the power tool 6. In order to remove the power tool 6 from the dolly 11, the stop yoke 32 is again pivoted from the second position into its first position so that the power tool 6 can be taken off the dolly 11.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-guided dolly for transporting heavy power tools, comprising:
two handlebars (12) defining a frame plane (E) and having at least one handle (13) in a first end region (14) thereof;
a load shovel (16) provided at a second end region (15) of the handlebars (12) and projecting away from the frame plane (E) substantially perpendicular thereto;
at least one running wheel (21) a wheel axle (23) of which extends parallel to the frame plane (E); and
a holding device (31) for a heavy power tool (6) and including a stop yoke (32) pivotal about a pivot axis (33) between a first position in which the power tool (6) can be placed on the dolly (11), and a second position in which the power tool (6) is secured on the dolly (11) with the stop yoke (32) for being transported on the dolly (11).

2. A dolly according to claim 1, wherein the pivot axis (33) of the stop yoke (32) extends parallel to the frame plane (E).

3. A dolly according to claim 1, wherein the pivot axis (3) of the stop yoke (32) is located in front of the frame plane (E) on a side of the plane (E) on which the load shovel (16) is located.

4. A dolly according to claim 1, wherein the stop yoke (32) is provided with a handle section (34).

5. A dolly according to claim 4, wherein the handle section (34) is formed by a bent section of the stop yoke (32).

6. A dolly according to claim 1, further comprising a spring element (35) for biasing the stop yoke (32) to one of the first and second position.

7. A dolly according to claim 6, wherein the spring element biases the stop yoke to the second position.

8. A dolly according to claim 1, further comprising at least one stop (36) for limiting a maximal pivotal movement of the stop yoke (32).

9. A dolly according to claim 8, wherein the stop (36) is formed by a bent section of the stop yoke (32) that extends form the pivot axis (33) through the frame plane (E) defined by the handlebars (12).

10. A dolly according to claim 1, wherein the stop yoke (32) has a connection section (37) located with respect to the load shovel (16) behind the frame plane (E).

11. A dolly according to claim 10, wherein a coupling section (38) is provided on the connection section (37) for engagement by a lifting device.
